(19) United States
(12) Patent Application Publication
(10) Pub. No.: US 2019/0089927 A1
(43) Pub. Date: Mar. 21, 2019

(54) BLOCK-BASED POWER EFFICIENT TIMING ENGINE FOR SMART DISPLAY PANELS

(71) Applicant: QUALCOMM Incorporated, San Diego, CA (US)

(72) Inventors: Rajesh Yadav, Hyderabad (IN); Dileep Marchya, Hyderabad (IN)

(21) Appl. No.: 15/710,638

(22) Filed: Sep. 20, 2017

(51) Int. Cl. H04N 5/92; H04N 5/44; G06T 1/60; H04N 5/05; H04N 5/907; H04N 5/915

(52) U.S. Cl. CPC H04N 5/92; H04N 5/44; H04N 5/915; H04N 5/05; H04N 5/907; G06T 1/60

(57) ABSTRACT

The techniques of this disclosure include power optimal multiplexing of host and/or panel random access memory (RAM) pixel data for display scan out. Two aspects include systems and methods of bypassing the memory on the smart display panel in certain circumstances and refreshing the display from the host: hardware enhancement for an optimal block-based timing engine for smart display panels and an optimized frame-based timing engine scan out for smart display panels. The host may determine whether to bypass the memory of the smart display based on the size of high refresh rate regions and/or offline data for non-updating regions from the host and RAM respectively. By bypassing the panel RAM during circumstances where large areas of the display are updated rapidly, display power usage and on-panel RAM wear out may be reduced.

### TECHNICAL FIELD

The present disclosure relates to display processing.

### BACKGROUND

Computing devices often use displays to output visual data. Smart panels (also referred to as a command mode display architecture) may include on-panel memory which may store content to be displayed. The content may comprise a complete frame of image data. A host processor (e.g., a display processor on a host device) is typically not required to update the on-panel memory of a smart display panel with any particular timing scheme. Instead, a timing engine on the smart display panel may serve the frame stored in memory for display. In contrast, a “dumb” display panel (also referred to as a video mode display architecture) may rely on the host processor to feed the display. The display panel is considered “dumb” because the display panel merely displays the provided content as served (e.g., by a host processor) rather than determining when to display the content.

### SUMMARY

The techniques of this disclosure include a power optimal multiplexing of host and/or panel random access memory (RAM) pixel data for display scan out. The term “host processor” refers to a display processor that provides source data to, and is distinct from, a display panel. Source data (e.g., a video layer and a graphical user interface (GUI) layer) enters a mixer where image and/or video surfaces are blended and stored in a buffer until the resulting data is transferred from the host processor to a smart display panel. The techniques include systems and methods of bypassing the memory (e.g., frame memory) on the smart display panel in certain circumstances (and refreshing the display from the host). Some examples provide hardware enhancement for an optimal block-based timing engine for smart display panels. Some examples provide optimized frame-based timing engine scan out for smart display panels. The host may determine whether to bypass the memory of the smart display panel based on the size of high refresh rate regions and/or offline data for non-updating regions from the host and RAM respectively. By bypassing the panel memory during circumstances where large areas of the display panel are updated rapidly, display power usage and on-panel RAM wear out may be reduced.

In one example, this disclosure describes a method of operating a display panel, the method comprising: receiving, by the display panel, content data from a host processor, the content data comprising content data for a first region of a first frame and content data for a second region of the first frame; storing the content data for the second region in an on-board memory of the display panel; displaying the first frame on a display screen of the display panel; receiving, by the display panel, updated content data for the first region from the host processor; retrieving, by the display panel, the stored content data for the second region from the on-board memory; generating, by the display panel, a second frame by multiplexing the updated content data for the first region and the stored content data for the second region, wherein the display panel generates the second frame in a way that bypasses storage in and retrieval from the on-board memory of the updated content data for the first region; and after displaying the first frame, displaying the second frame on the display screen.

In another example, this disclosure describes a method of operating a display panel, the method comprising: selecting, by a host device, a particular control mode from a plurality of control modes; instructing, by the host device, the display panel to operate in the particular control mode; sending, by the host device, content data to the display panel, the content data comprising content data for a first region of a first frame and content data for a second region of the first frame; and sending, by the host device, updated content data for the first region to the display panel, wherein instructing to the display panel to operate in the particular control mode configures the display panel to: store the content data for the second region in an on-board memory of the display panel; display the first frame on a display screen of the display panel; retrieve the stored content data for the second region from the on-board memory; generate a second frame by multiplexing the updated content data for the first region and the stored content data for the second region, wherein the display panel generates the second frame in a way that bypasses storage in and retrieval from the on-board memory of the updated content data for the first region; and after displaying the first frame, display the second frame on the display screen.

In another example, this disclosure describes a display panel comprising: an interface; an on-board memory; a display screen; and a display controller, wherein: the interface is configured to receive content data from a host processor, the content data comprising content data for a first region of a first frame and content data for a second region of the first frame, the on-board memory is configured to store the content data for the second region, the display screen is configured to display the first frame, the interface is further configured to receive updated content data for the first region from the host processor, and the display controller is configured to: retrieve the stored content data for the second region from the on-board memory; and generate a second frame by multiplexing the updated content data for the first region and the stored content data for the second region, wherein the display controller generates the second frame in a way that storage in and retrieval from the on-board memory of the updated content data for the first region is bypassed; and the display screen is configured to display the second frame after displaying the first frame.

In another example, this disclosure describes a host device for operating a display panel, the host device comprising: an interface; and a host processor configured to: select a particular control mode from a plurality of control modes; instruct, via the interface, the display panel to operate in the particular control mode; send, via the interface, content data to the display panel, the content data comprising content data for a first region of a first frame and content data for a second region of the first frame; send, via the interface, updated content data for the first region to the display panel, wherein instructing to the display panel to operate in the particular control mode configures the display panel to: store the content data for the second region in an on-board memory of the display panel; display the first frame on a display screen of the display panel; retrieve the stored content data for the second region from the on-board memory; generate a second frame by multiplexing the updated content data for the first region and the stored content data for the second region, wherein the display panel generates the second frame in a way that bypasses storage in and retrieval from the on-board memory of the updated content data for the first region; and after displaying the first frame, display the second frame on the display screen.

The details of one or more aspects of the present disclosure are set forth in the accompanying drawings and the description below. Other features, objects, and advantages of the present disclosure will be apparent from the description, drawings, and claims.

### BRIEF DESCRIPTION OF DRAWINGS

FIG. 1 is a block diagram illustrating an example system comprising a computing device and a display panel that may be configured to implement one or more aspects of this disclosure.

FIG. 2A illustrates a first set of exemplary application display content on an exemplary mobile device according to techniques of the present disclosure.

FIG. 2B illustrates a second set of exemplary application display content on an exemplary mobile device according to techniques of the present disclosure.

FIG. 3 is a flowchart illustrating an example method of mode selection in a block-based power efficient timing system according to aspects of the present disclosure.

FIG. 4 is a flowchart illustrating an example method of mode selection in a frame-based power efficient timing system according to aspects of the present disclosure.

FIG. 5 is a flowchart illustrating an example method of operating a display panel using a block-based timing engine according to aspects of the present disclosure.

FIG. 6 is a flowchart illustrating an example operation of a host device using a block-based timing engine according to aspects of the present disclosure.

FIG. 7 is a flowchart illustrating an example method of operating a display panel using a frame-based timing engine according to aspects of the present disclosure.

FIG. 8 is a flowchart illustrating an example method of operating a display panel using a frame-based timing engine according to aspects of the present disclosure.

FIG. 9 is a flowchart illustrating an example operation of a host device using a block-based timing engine according to aspects of the present disclosure.

### DETAILED DESCRIPTION

Smart display panels may include on-board memory (e.g., random access memory (RAM)) which may be used to refresh the display autonomously. In this disclosure, a smart display panel, or a system that includes a smart display panel, may be said to operate in a command mode. A smart display panel includes on-panel memory which may store a complete frame which a host processor is not required to update. In contrast, a “dumb” display panel may rely on a host processor to feed content to the display panel. In this disclosure, a “dumb” display panel may be said to operate in a video mode.

When a computing device is using a smart display panel, an overlay engine of a host processor of the computing device transmits a pixel data stream to the smart display panel for storage in an on-board memory of the smart display panel. In some examples, the overlay engine is a mobile display processor (MDP) designed to perform 2-dimensional (2D) operations on image data to be displayed. Example types of 2D operations include blending, compositing, overlay, rotating, upscaling, downscaling, and stretching. The overlay engine may not be required to supply data to the smart display panel at a constant rate as the smart display panel is refreshed from the on-board memory of the smart display panel.

In many circumstances, only a portion of the content displayed by a display panel is changing. For example, consider a webpage that includes a moving video while the rest of the webpage remains static. Thus, in this example, only the portion of the webpage comprising the video may need to be updated (i.e., redrawn). The use of a smart display panel may save costs associated with redundant data transfer when either a source refresh rate is lower than a display refresh rate or when only a portion of the display content has been redrawn. A source refresh rate is a rate at which the host processor sends content data to a display panel. A display refresh rate is a rate at which a display panel refreshes what content is being displayed by the display panel. For example, when a computing device is using a smart display panel and a portion of the display content does not change, a host processor of the computing device does not need to resend the unchanged portions of the display content to the smart display panel because a copy of the unchanged portions of the display content is already stored in the on-board memory of the smart display panel. In this example, the smart display panel may continue using the copy of the unchanged changed portioned of the display content to output the display content data for display. Not resending the unchanged portions of the display content may reduce the amount of electrical energy consumed by the computing device. Additionally, not resending the unchanged portions of the display content may make more bandwidth available on a transmission path from the host processor to the smart display panel for portions of the display content that are changing. Because of the increased bandwidth in the transmission path, the smart display panel may able to receive updated display content more frequently, which may improve the experience for a user.

As noted above, the on-board memory of the smart display panel may store display content from a host processor before the smart display panel scans the display content out for display. Despite the advantages of smart display panels discussed above, there are also challenges and problems associated with smart display panels. For example, the memory write and read operations may become a source of overhead in those instances where the source refresh rate is approximately equivalent to display refresh rate. Techniques of this disclosure may address particular challenges and problems associated with smart display panels. For instance, in accordance with a technique of this disclosure, the overhead associated with memory read and write operations may be reduced by not always updating the on-board memory of the smart display panel. According to the techniques of this disclosure, this may occur if the on-board memory of the smart display panel is bypassed, in certain circumstances, in whole (e.g., the entire frame) or in part (e.g., a block of the frame). For example, the read and write operations associated with use of the on-board memory of a smart display panel may result in the smart display panel consuming 20 mA of extra electrical power as compared to a dumb display panel when a source refresh rate is 60 frames per second (fps), a resolution of the display content is 1440×2560 pixels, and the smart display panel and the dumb display panel are liquid crystal displays (LCDs) having display refresh rates of 60 Hz.

The techniques of this disclosure may provide a power optimal multiplexing of content data from a host processor and/or content data from the on-board memory of the display panel. More simply, in certain circumstances, the host processor bypasses the on-board memory of the smart display processor. The term “host processor” may refer to a processor (e.g., a display processor) that provides content data to, and is distinct from, a display panel. Content data may also be referred to herein as source data. As described herein, content data (e.g. a video layer and/or a graphical user interface (GUI) layer) may enter a mixer of a host processor where image/video surfaces are blended and stored in a buffer until the data transfers from the host processor to a smart display panel. Two aspects of the present techniques include systems and methods of bypassing the on-board memory of the smart display panel in certain circumstances (and refreshing the display directly from the host processor): (1) hardware enhancement for an optimal block-based timing engine for smart display panels; and (2) an optimized frame-based timing engine scan out for smart display panels. The host processor may determine whether to bypass the on-board memory of the smart display panel based on a size of high-refresh-rate regions and/or a size of non-updating or low-refresh-rate regions, respectively. By bypassing the on-board memory of the smart display panel during circumstances where large areas of the display content are updated rapidly, techniques of the present disclosure may represent a significant advantage for display power usage. In addition, for similar reasons, techniques of this disclosure may reduce on-panel memory wear out.

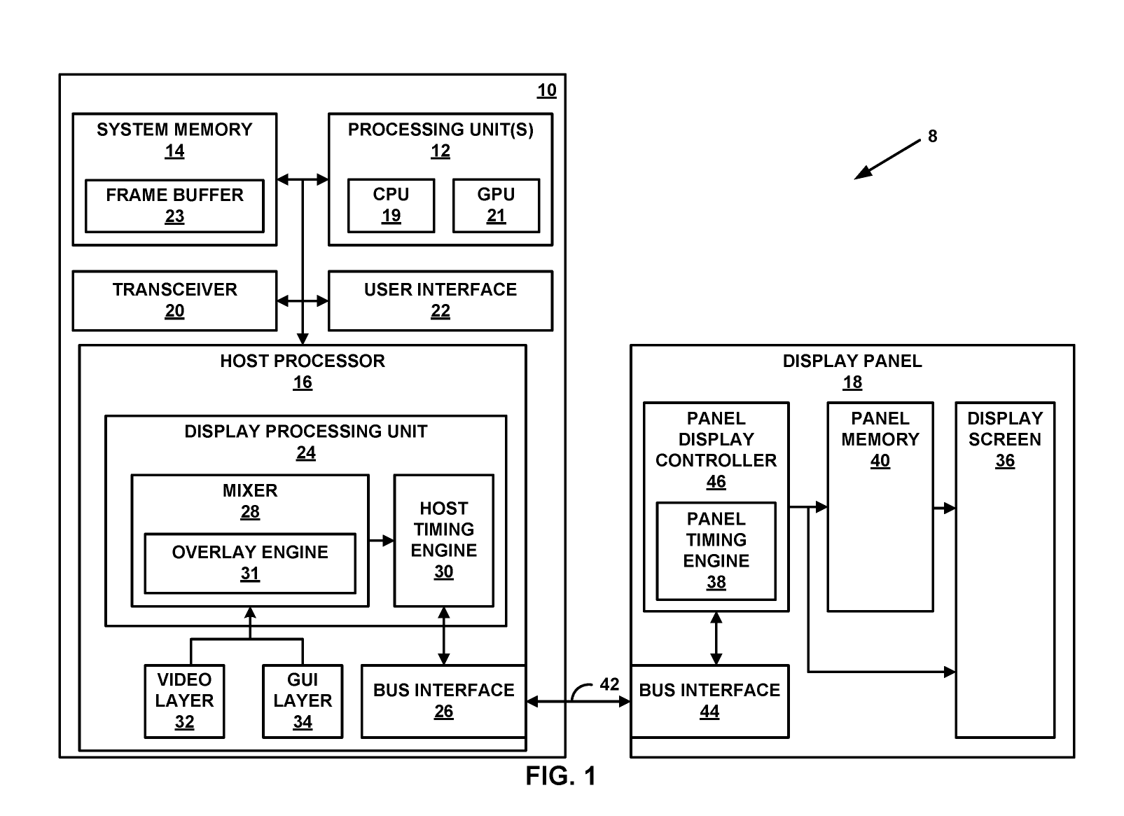

FIG. 1 is a block diagram illustrating an example system 8 comprising a computing device 10 and a display panel 18 that may be configured to implement one or more aspects of this disclosure. Computing device 10 is an example of a “host device.” Computing device 10 may be a video device, a media player, a set-top box, a wireless handset such as a mobile telephone or a so-called smartphone, a personal digital assistant (PDA), a desktop computer, a laptop computer, a gaming console, a video conferencing unit, a tablet computing device, or another type of computing device.

In the example of FIG. 1, computing device 10 includes processing unit(s) 12 (e.g., a central processing unit (CPU) and/or graphics processing unit (GPU)), a system memory 14, a host processor 16, a transceiver 20, and a user interface 22. Computing device 10 may communicate with display panel 18. In some examples, display panel 18 is an included component of computing device 10. In other examples, display panel 18 is external to computing device 10 and computing device 10 communicates with display panel 18. In some examples where display panel 18 is external to computing device 10, display panel 18 comprises an external monitor, television, or projector. In other examples, display panel 18 is internal to an integrated device with a built-in display such as a smartphone, tablet computer, or laptop computer.

In the example of FIG. 1, display panel 18 includes a display screen 36, a panel memory 40, a bus interface 44, and a panel display controller 46. Display screen 36 may display image content generated by computing device 10 (with e.g., processing unit(s) 12), e.g., such as rendered graphics data, video data, interface and GUI overlay data. Display screen 36 may be a Liquid Crystal Display (LCD), an organic light emitting diode display (OLED), a cathode ray tube (CRT) display, a plasma display, electronic ink, or another type of display device.

It should be understood that other examples of computing device 10 and display panel 18 may include more, fewer, or an alternative arrangement of components than those shown. For example, computing device 10 may include a speaker and/or a microphone, neither of which are shown in FIG. 1, to effectuate telephonic communications in examples where computing device 10 is a mobile wireless telephone. In examples where computing device 10 is a media player, computing device 10 may include a speaker. Computing device 10 may also include a video camera. In some examples, certain units such as transceiver 20 or host processor 16 are part of the same integrated circuit (IC) as processing unit(s) 12, may be external to an IC or ICs that include processing unit(s) 12, or may be formed in an IC that is external to an IC that includes processing unit(s) 12.

Processing unit(s) 12 may include a CPU 19 that comprises a general-purpose or a special-purpose processor that controls operation of computing device 10. For example, CPU 19 may include one or more processors, such as one or more microprocessors, application-specific integrated circuits (ASICs), field-programmable gate arrays (FPGAs), digital signal processors (DSPs), or other equivalent integrated or discrete logic circuitry.

Processing unit(s) 12 may also include a GPU 21. CPU 19 may issue one or more graphics rendering commands to GPU 21 to cause GPU 21 to render graphics data. GPU 21 may include a programmable pipeline of processing components having a highly parallel structure that provides efficient processing of complex graphics-related operations. GPU 21 may include one or more processors, such as one or more microprocessors, ASICs, FPGAs, DSPs, or other equivalent integrated or discrete logic circuitry. GPU 21 may also include one or more processor cores, such that GPU 21 may be referred to as a multi-core processor. In some instances, GPU 21 is integrated into a motherboard (not shown) of computing device 10. In other instances, GPU 21 may be present on a graphics card (not shown) that is installed in a port in the motherboard of computing device 10 or may be otherwise incorporated within a peripheral device configured to interoperate with computing device 10.

Processing unit(s) 12 may output rendered data to system memory 14. System memory 14 may store instructions that, when executed by processing unit(s), cause computing device 10 to provide an operating system that controls the operation of components of computing device 10. System memory 14 may also be used by software or applications (as described below) executed by computing device 10 to store information during program execution. System memory 14 may include a computer-readable storage medium or a computer-readable storage device. In some examples, system memory 14 includes one or more of a short-term memory or a long-term memory. System memory 14 may include, for example, RAM, dynamic DRAM, static SRAM, cache memory, magnetic hard discs, optical discs, flash memories, or forms of electrically programmable memories (EPROM) or electrically erasable and programmable memories (EEPROM). Similarly, panel memory 40 may include, for example, RAM, dynamic DRAM), static SRAM, cache memory, magnetic hard discs, optical discs, flash memories, or forms of EPROM or EEPROM.

System memory 14 may include a frame buffer 23 that stores pixels for processing by processing unit(s) 12 and/or host processor 16. Each pixel may be associated with a unique screen pixel location. In some examples, frame buffer 23 stores color components and a destination alpha value for each destination pixel. For example, frame buffer 23 may store Red, Green, Blue, Alpha (RGBA) components for each pixel where the “RGB” components correspond to color values and the “A” component corresponds to a destination alpha value (e.g., a transparency value that may be used in compositing, which may also be referred to as opacity). In some examples, frame buffer 23 is a separate unit than system memory 14.

Transceiver 20 may include circuitry to allow wireless or wired communication between computing device 10 and another device or a network. Transceiver 20 may include modulators, demodulators, amplifiers, and other such circuitry for wired or wireless communication.

User interface 22 may allow a user to provide input to computing device 10. Examples of user interface 22 include, but are not limited to, a trackball, a mouse, a keyboard, and other types of input devices. User interface 22 may also be a touch screen and may be incorporated as a part of display panel 18.

In the example of FIG. 1, host processor 16 further includes a display processing unit 24 and a bus interface 26. Furthermore, in the example of FIG. 1, display processing unit 24 includes a mixer 28 and a host timing engine 30. Video layer 32 and GUI layer 34 are inputs to mixer 28 that may be stored in a memory, such as system memory 14. Host processor 16 may connect to other devices such as display panel 18 via bus interface 26, for example, over a link 42.

Video layer 32 includes video and graphics content. The video content may have been produced locally (via e.g., a camera on computing device 10), or may be produced on an external device and retrieved or downloaded by, e.g., transceiver 20 of computing device 10. Processing unit(s) 12 may decode video in video layer 32 for playback.

GUI layer 34 includes other graphical elements that provide a user interface. These interface elements include for example a camera interface software (e.g., a “shutter” button, camera switch buttons, settings, and menus), media player interface (e.g., play/pause buttons, menus, and settings), operating system/program interfaces including an interface to scroll through installed applications, settings, menus, and internet/web browser interfaces.

Display processing unit 24 may receive pixel data, e.g., from video layer 32 and GUI layer 34. In the example of FIG. 1, mixer 28 includes an overlay engine 31 (e.g., mobile display processor (MDP)) designed to perform 2D operations on image data to be displayed (e.g., blending compositing, overlay, rotating, upscaling, downscaling, and stretching). Overlay engine 31 may be configured to update panel memory 40 at a variable or constant rate as display screen 36 may be refreshed from panel memory 40. Mixer 28 may blend, composite, or overlay different GUI elements from GUI layer 34 over video/graphical elements from video layer 32 into a display view. The display view is the combination of video/graphical and GUI elements (overlays) that a user is able to view on display screen 36 of display panel 18 and interact with via user interface 22.

Host timing engine 30 is configured to generate a desired timing based on several factors such as a display refresh rate, a display resolution, and panel (e.g., horizontal and vertical, front and back) porches. Host timing engine 30 receives the display view from mixer 28 and may determine whether to send display view(s) (i.e., content data) or portions of the display view(s) to display panel 18 and timing (frequency of and synchronicity) to send the display view(s) or portions of the display view(s) to display panel 18. Host timing engine 30 may be configured to scan pixel data to display panel 18 based on a determined refresh rate. Data such as display views may be sent either at a constant rate (e.g., constant frequency) or at a variable rate. Host timing engine 30 may communicate with a panel timing engine 38 of display panel 18. Such communications may include instructions to direct panel timing engine 38 or determine whether to bypass panel memory 40 on display panel 18 or to use panel memory 40 and display the view (via display screen 36) from panel memory 40. Host timing engine 30 and panel timing engine 38 may include a handshake to coordinate synchronization of the data to be sent.

Host timing engine 30 of display processing unit 24 may send instructions to display panel 18 over link 42 using bus interface 26. Bus interface 26 of host processor 16 may communicate with bus interface 44 of display panel 18 over link 42. Link 42 may include a bus connection such as a Display Serial Interface (DSI) point-to-point serial bus connection or other physical wired (e.g., High-Definition Multimedia Interface (HDMI) or digital video interface (DVI) connection) or wireless links such as DisplayPort (or variants such as embedded DisplayPort (eDP) or wireless DisplayPort (wDP)) or Wi-Fi Display.

Panel display controller 46 may be configured to receive pixel data from host processor 16 and store the data in panel memory 40 for later display on display screen 36 or to bypass panel memory 40 and send pixel data directly to display screen 36. Panel timing engine 38 of panel display controller 46 may be configured to determine a refresh rate for all or part of the display screen 36 and send the pixel data at the appropriate interval to refresh display screen 36. Panel timing engine 38 may determine the timing interval based on instructions received from host processor 16 or may do so independently based on the source and type of pixel data.

Panel memory 40 may include bitmap or a portion of a bitmap containing all or a portion of a frame of data to be displayed on display screen 36. Panel memory 40 may include a frame buffer which converts an in-memory bitmap (or a portion of a bitmap) into a video signal for use by display screen 36. Display screen 36 may receive pixel information from panel display controller 46 and/or panel memory 40 and cause the pixels of display screen 36 to illuminate to display the image at a refresh interval set by panel timing engine 38.

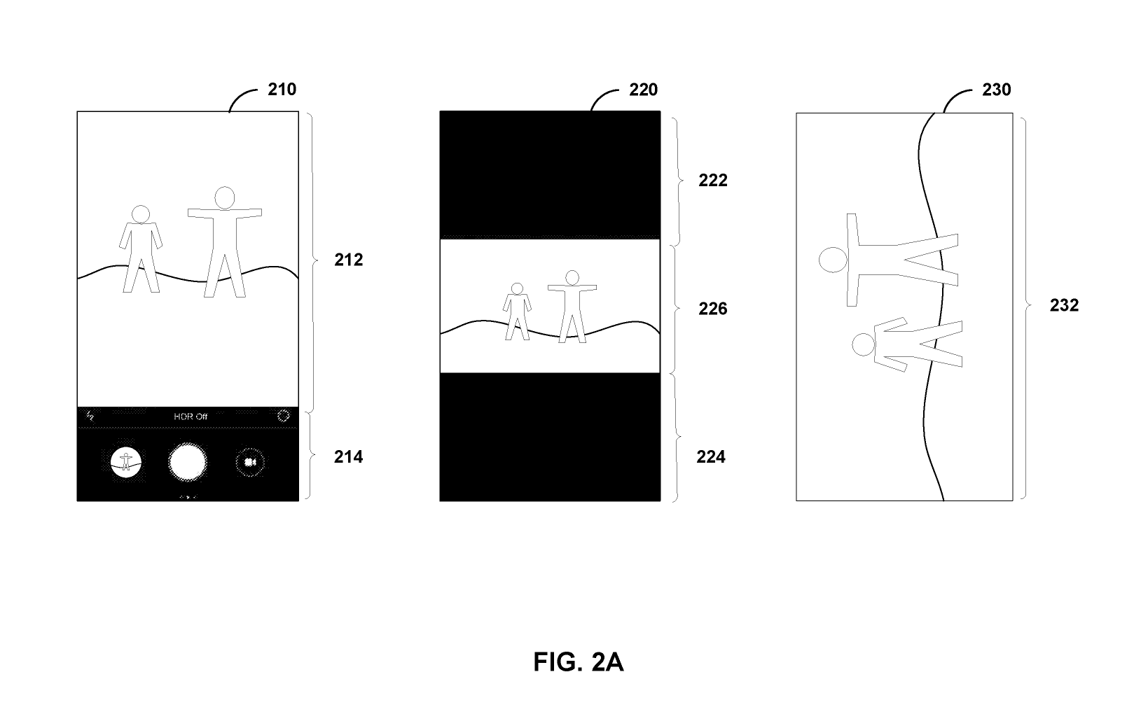

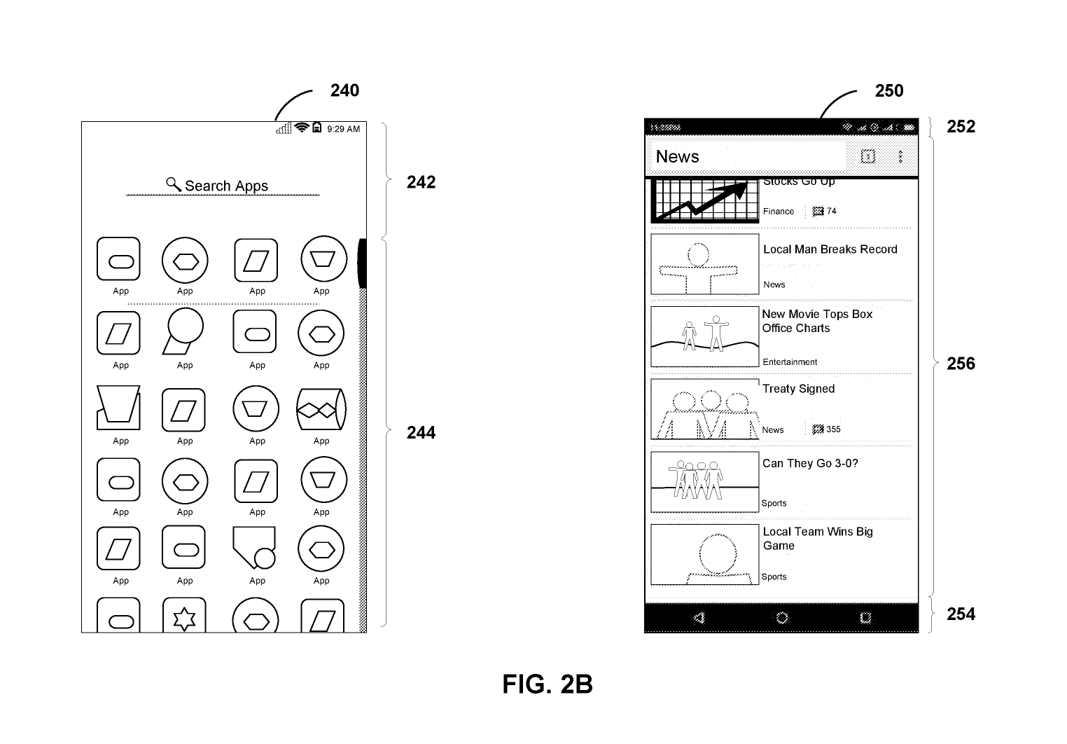

FIG. 2A illustrates a first set of exemplary application display content on an exemplary mobile device according to techniques of the present disclosure. FIG. 2B illustrates a second set of exemplary application display content on an exemplary mobile device according to techniques of the present disclosure. According to techniques of the present disclosure, different regions in a display may have different refresh rates. Refresh rates may be measured in frames per second (FPS). Low-refresh-rate regions may be determined to have a low number of updated FPS, whereas high-refresh-rate regions may be determined to have a high number of updated FPS. In some examples, a high refresh rate includes a refresh rate of 30 or 60 frames per second or more. A low refresh rate may include content with a refresh rate of 15 FPS or less. In other examples, a determination of whether a region has a high or low refresh rate depends on the relative refresh rates of other regions in the display frame.

In the example of FIG. 2A, camera application display content 210 (FIG. 2A) illustrates a camera preview screen on a mobile device. Camera application display content 210 includes a region 212, the camera preview window, which host processor 16 may determine to be a high-refresh-rate region. Camera application display content 210 also includes a control region 214 of the camera application that host processor 16 may determine to be a low-refresh-rate region.

Display content 220 (FIG. 2A) illustrates a media player in a letterbox mode. Regions 222 and 224 are letterbox mattes, which host processor 16 may determine to be low-refresh-rate regions. Region 226 is the media viewing window, which host processor 16 may determine to be a high-refresh-rate region.

Display content 230 (FIG. 2A) illustrates a media player in a full-screen viewing mode. The entire screen, shown in region 232, may be a high-refresh-rate region. Display content 230 does not include any low-refresh-rate regions.

Display content 240 (FIG. 2B) illustrates a launcher scroll screen. Host processor 16 may determine that region 242 of display content 240 is a low-refresh-rate region. When a user is scrolling through applications on the device, host processor 16 may determine that region 244 of display content 240 is a high-refresh-rate region.

Display content 250 (FIG. 2B) illustrates a browser window. Region 252 of display content 250 is a status bar and region 254 is a navigation bar. Host processor 16 may determine that regions 252 and 254 are low-refresh-rate regions. Region 256 is a browser window which may include a high-refresh-rate rate region when a user is scrolling.

Regions that refresh at a high rate or low rate are not static. For example, when a user is actively scrolling through applications or a browser window active regions 244 and 256 are updated at a relatively fast rate. When a user stops scrolling, the regions 244 and 256 may not update as quickly and thus host processor 16 may determine regions 244 and 256 to be low-refresh-rate regions. In another example, regions 226 and 232 illustrate media player windows. During video playback, regions 226 and 232 may have a high refresh rate and when paused these same regions 226 and 232 may have a low refresh rate. High and low refresh rate regions may be based on the source frame rate.

Techniques of the present disclosure include a power-optimal multiplexing of pixel data (i.e., content data) from panel memory 40 and/or pixel data from host processor 16 that bypasses panel memory 40. In a first aspect, a block-based timing engine may determine that blocks (e.g., regions) of a display frame are high-refresh-rate regions. In those regions, host timing engine 30 (and in some examples, panel timing engine 38) may determine that panel memory 40 should be bypassed for the high-refresh-rate regions and timing (e.g., display screen 36 refresh) may be controlled by host timing engine 30. In the lower-refresh-rate regions, panel timing engine 38 may control timing and panel memory 40 provides the regions for display on display screen 36. In a second aspect, an optimized frame-based timing engine scan out is used. In this aspect, host processor 16 (or panel display controller 46), determines whether panel memory 40 on display panel 18 is used (and display scan out is controlled by panel timing engine 38) or bypassed (and display scan out is controlled by host timing engine 30).

In the block-based aspect, display controller 46 refreshes display screen 36 by multiplexing content data for high-refresh-rate regions with content data for low-refresh-rate regions. Panel display controller 46 does not store or retrieve the display content data for high-refresh-rate regions in panel memory 40. However, panel display controller 46 does store display content data for the low-refresh-rate regions in panel memory 40 and retrieve the display content data for the low-refresh-rate regions from panel memory 40. In some examples, host processor 16 separates out regions that host processor 16 and/or the host timing engine 30 of host processor 16 control directly (e.g., the regions that update frequently and therefore do not need to be stored in panel memory 40 prior to multiplexing and display, such as camera preview region 212 (FIG. 2A) of the camera application display 210) from low-refresh-rate regions (e.g., the shutter button control region 214 of the camera application display content 210 that may change when a user presses the shutter button on the screen). A master-slave timing engine control model is set up by host timing engine 30 where host timing engine 30 is configured to act as the master and panel timing engine 38 is configured to act as the slave. Thus, host timing engine 30 may send instructions to panel timing engine 38 to bypass panel memory 40 and to send data directly to display screen 36 for specific high-refresh blocks and/or to refresh display screen 36 with pixel data stored in panel memory 40 for other low-refresh blocks. Instructions may also include refresh/timing information. In another example, panel timing engine 38 may act as the master and host timing engine 30 as the slave. In such an example, panel timing engine 38 instructs host timing engine 30 regarding what data to send (e.g., the entire frame of pixel data or only specific portions of the frame).

Three modes are defined in this aspect for control: (i) “no frame control” mode, (ii) “partial frame control” mode, and (iii) “full frame control” mode. These control modes are described in detail below.

In the “no frame control” mode, host processor 16 updates panel memory 40 with the latest frame buffer and may relinquish timing engine control to the slave timing engine (e.g., panel timing engine 38 of display panel 18). The slave timing engine (e.g., panel timing engine 38 of display panel 18) may refresh display screen 36 autonomously until interrupted.

In “partial frame control” mode, host processor 16 determines blocks which shall be refreshed on-the-fly (from e.g., host processor 16) and which blocks shall be refreshed offline. This disclosure uses the term “block” interchangeably with “region.” In this disclosure, a block is said to be refreshed offline if display panel 18 refreshes the block from panel memory 40 without receiving updated display content of the block from host processor 16. In some examples, blocks are line based. For example, a block may consist of one or more horizontal lines of pixels (i.e., rows of pixels) or one or more vertical lines of pixels (i.e., columns of pixels). Thus, in this disclosure, the term “line block” refers to either a set of consecutive rows of pixels or a set of consecutive columns of pixels. In examples where a block consists of a single row of pixels or a single column of pixels, host processor 16 may identify the block to display panel 18 by signaling a line number (e.g., a row number or a column number). In examples where a block consists of multiple rows or columns of pixels, host processor 16 may identify the block to display panel 18 by signaling a line range (e.g., starting and ending rows or starting and ending columns). In some examples, the smallest block is a single line of pixels.

In other examples, blocks are region based (e.g., based on rectangular, circular, or amorphous regions and may be signaled based on pixel coordinates of corners, pixel coordinates of a central point in a circular region and a pixel radius, or pixel outlines, respectively). In other examples, host processor 16 may send out pixel data for the panel-controlled blocks separately from pixel data for the host-controlled blocks.

Furthermore, in partial frame control mode, host processor 16 may instruct the master timing engine (e.g., host timing engine 30) to start a display refresh. In response, the master timing engine (e.g., host timing engine 30) may instruct the slave timing engine (e.g., panel timing engine 38) for any offline block refresh on demand (e.g., as instructed rather than at a regular interval or never). Instructions sent by host processor 16 to display panel 18 during “no frame control” and “full frame control” modes may not need to include region specific instructions/delineations. In another example, host processor 16 may send the entire frame (e.g., both high and low refresh rate blocks) to display panel 18 and panel display controller 46 of display panel 18 may only display part of the frame (e.g., the high-refresh-rate blocks) and display other regions (e.g., the low-refresh-rate blocks) from panel memory 40. Coordination between host processor 16 and display panel 18 may involve a handshake process between host timing engine 30 of host processor 16 and panel timing engine 38 of display panel 18.

In “partial frame control” mode, in one example, panel memory 40 is configured to be accessed randomly (e.g., at any location) as only particular parts of a frame are being displayed on display screen 36 from panel memory 40 (the other portion may be displayed on display screen 36 while bypassing panel memory 40). In another example, panel memory 40 has only the relevant (e.g., low-refresh-rate) blocks stored adjacent to one another. In this example, panel timing engine 38 or panel display controller 46 on display panel 18 may store a mapping of areas of the pixel locations of blocks to be displayed corresponding to memory addresses in panel memory 40. In this example, a bitmap of pixels may be stored in panel memory 40 corresponding to the scan out locations of the pixels. Similarly, system memory 14 or memory on host processor 16 may also use random access or mapping during, at least, partial frame control mode. In partial frame control mode, regions of panel memory 40 may be powered off. In partial frame control mode, panel display controller 46 may multiplex pixel data received on-the-fly from host processor 16 with data stored in panel memory 40. Because the timing of host timing engine 30 and panel timing engine 38 is synchronized, content data for a first portion of a frame arrives from host processor 16 at panel display controller 46 at the time that panel display controller 46 is to scan out the content data for the first portion of the frame to display screen 36 and panel display controller 46 receives content data of a second portion of the frame from panel memory 40 at the time that panel display controller 46 is to scan out the content data for the second portion of the frame to display screen 36.

In “full frame control” mode, host processor 16 may instruct the master timing engine (e.g., host timing engine 30) to start a full display refresh on the fly and bypass panel memory 40 of display panel 18. Accordingly, in the “full frame control” mode, power is not consumed by reading or writing data to panel memory 40. In some examples of the “full frame control” mode, display panel 18 does not provide electricity to panel memory 40 because panel display controller 46 does not use panel memory 40.

For example, region 214 (FIG. 2A) of camera application display content 210 may be identified as a low-refresh-rate region whereas region 212 may be identified as a high-refresh-rate region. In an example operation, host processor 16 may determine the optimal mode is partial frame control mode and host processor 16 may designate region 214 as a block where timing is controlled by panel timing engine 38 (using panel memory 40). Additionally, host processor 16 may designate region 212 as a block where timing is controlled by host timing engine 30 (bypassing panel memory 40).

In the example of display content 220 (FIG. 2A), regions 222 and 224 of display content 220 may be identified as having a low-refresh-rate whereas region 226 may be identified as a high-refresh-rate region. In an example operation, host processor 16 may determine the optimal mode is partial frame control mode and may designate regions 222 and 224 as blocks where timing is controlled by panel timing engine 38 (using panel memory 40). Additionally, host processor 16 may designate region 226 as a block where timing is controlled by host timing engine 30 (bypassing panel memory 40). Host processor 16 may instruct panel timing engine 38 which blocks (e.g., regions 222 and 224) are to be refreshed by panel timing engine 38 in the form of a bitmap. For example, host processor 16 may use a bitmap that contains different values (e.g., 0's and 1's) to indicate whether individual pixels are refreshed by host processor 16 and which pixels are refreshed by panel display controller 46.

Both host timing engine 30 and panel timing engine 38 are synchronized to begin at the same time. A master/slave relationship by host timing engine 30 and panel timing engine 38 may dictate the start of panel timing engine 38 by host processor 16. Panel timing engine 38 may begin refreshing region 222 from panel memory 40 independently. Host timing engine 30 may begin transmitting a second block directly (bypassing panel memory 40) without any intervention by panel timing engine 38. In this portion of the process, no data is stored in panel memory 40. Panel timing engine 38 may remain idle in the duration host timing engine 30 sends pixel data for region 226 to display panel 18 for display. Panel timing engine 38 may then begin to transfer pixel data associated with region 224 once the display of pixel data associated with region 226 is complete. In some examples, host timing engine 30 and panel timing engine 38 do not operate actively at the same time (e.g., mutually exclusive operation). In other examples, host timing engine 30 and panel timing engine 38 operate concurrently to refresh different parts of display screen 36.

In the example of display content 230 (FIG. 2A), host processor 16 may identify region 232 of display content 230 as a high-refresh-rate region. In an example operation, host processor 16 may determine the optimal mode is full-frame control mode as the entire frame (including region 232) is determined to be a high-refresh-rate region. Thus, the entire frame may be controlled by host processor 16 (bypassing panel memory 40). In such an example, panel memory 40 is bypassed entirely.

In the example of display content 240 (FIG. 2B), host processor 16 may identify region 242 of display content 240 as a low-refresh-rate region, whereas host processor 16 may identify region 244 as a high-refresh-rate region when a user is actively scrolling. In an example operation, host processor 16 may determine the optimal mode is partial frame control mode and host processor 16 may designate region 242 as a block where timing is controlled by panel timing engine 38 using panel memory 40. Additionally, host processor 16 may designate region 244 as a block where timing is controlled by host timing engine 30 (bypassing panel memory 40).

In the example of display content 250 (FIG. 2B), host processor 16 may identify regions 252 and 254 of display content 250 as having a low-refresh-rate, whereas host processor 16 may identify region 256 as a high-refresh-rate region. In an example operation, host processor 16 may determine the optimal mode is partial frame control mode and host processor 16 may designate regions 252 and 254 as blocks where timing is controlled by panel timing engine 38 using panel memory 40. Additionally, host processor 16 may designate region 256 as a block where timing is controlled by host timing engine 30, bypassing panel memory 40.

In the frame-based aspect of this disclosure, panel timing engine 38 may initially control display scan out. Host processor 16 may activate host timing engine 30 or panel timing engine 38 control such that a composed frame buffer is either refreshed on-the-fly (e.g., bypassing panel memory 40) or offline (e.g., using panel memory 40).

Display processing unit 24 may send instructions over link 42 to panel display controller 46 to read content data from panel memory 40 or to display content data provided by host processor 16 using the provided timing while bypassing panel memory 40. When host timing engine 30 controls timing, host processor 16 may send pixel data at the time for display. In this example, panel memory 40 may also be powered off. When display panel 18 controls timing, host processor 16 may send pixel data to display panel 18 via link 42 and panel display controller 46 may control display scan out timing of display/update pixel data on display screen 36.

For example, host processor 16 may identify region 214 (FIG. 2A) of camera application display content 210 as a low-refresh-rate region, whereas host processor 16 may identify region 212 as a high-refresh-rate region. Because the high-refresh-rate regions of camera application display content 210 are larger than the low-refresh-rate regions of camera application display content 210, host processor 16 determines that host timing engine 30 is to be activated (e.g., for on-the-fly multiplexing and display bypassing panel memory 40) for all of camera application display content 210 while panel timing engine 38 is inactive with respect to all of camera application display content 210.

In the example of display content 220 (FIG. 2A), host processor 16 may identify regions 222 and 224 of display content 220 as having a low-refresh-rate, whereas host processor 16 may identify region 226 as a high-refresh-rate region. Because the high-refresh-rate regions of display content 220 are smaller than a given threshold, which in the case of the examples of FIG. 2A and FIG. 2B is a size of the low-refresh-rate regions, host processor 16 may determine that panel timing engine 38 is activated with respect to all of display content 220 while host timing engine 30 is inactive with respect to all of display content 220.

In the example of display content 230 (FIG. 2A), host processor 16 may identify region 232 of display content 230 as a high-refresh-rate region. Once again, because the high-refresh-rate regions of display content 220 are larger than the low-refresh-rate regions of display content 220 (since there are none), host processor 16 may determine that host timing engine 30 is activated with respect to all of display content 230 (e.g., for on-the-fly multiplexing and display bypassing panel memory 40) while panel timing engine 38 is inactive with respect to all of display content 230.

In the example of display content 240 (FIG. 2B), host processor 16 may identify region 242 of display content 240 as a low-refresh-rate region and may identify region 244 as a high-refresh-rate region. Because the high-refresh-rate regions of display content 240 are larger than the low-refresh-rate regions of display content 240, host processor 16 may determine that host timing engine 30 is activated (e.g., for on-the-fly multiplexing and display bypassing panel memory 40) for all of display content 240 and panel timing engine 38 is inactive for all of display content 240.

In the example of display content 250 (FIG. 2B), host processor 16 may identify regions 252 and 254 of display content 220 as low-refresh-rate regions and may identify region 256 as a high-refresh-rate region. Because the high-refresh-rate regions of display content 250 are larger than the low-refresh-rate regions of display content 250, host processor 16 may determine that host timing engine 30 is activated (e.g., for on-the-fly multiplexing and display bypassing panel memory 40) for all of display content 250 and panel timing engine 38 is inactive for all of display content 250.

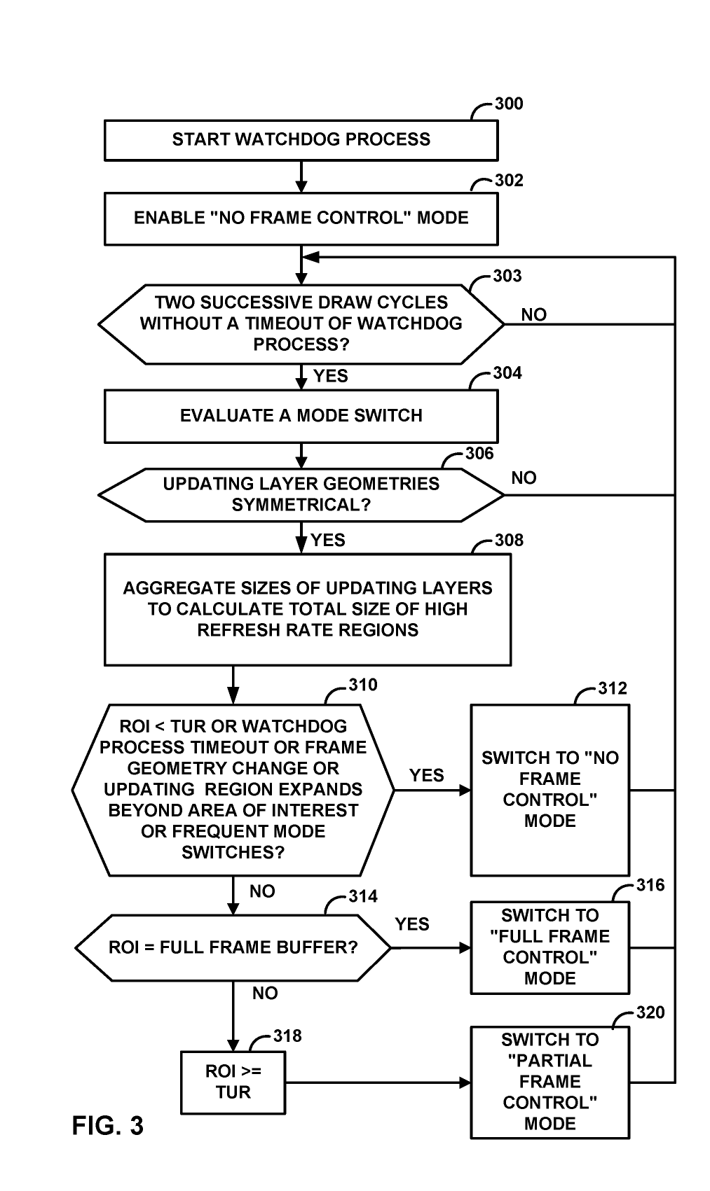

FIG. 3 is a flowchart illustrating an example method of mode selection in a block-based power efficient timing system according to aspects of the present disclosure. In this example, host processor 16 (or a display driver/display hardware in host processor 16 controlled via registers) may determine which frame control mode to select. While examples of the present techniques are described in terms of steps performed by host timing engine 30, examples are equally applicable to steps performed by the timing engine on the display panel.

Host processor 16 may start a watchdog process (300). In another example, a display driver on CPU 19 or display processor hardware may run the watchdog process. In either case, the watchdog process is a monitoring process configured to monitor the refresh rate of different regions in frames of display content. The watchdog process may monitor the source content in system memory 14 or in a memory on host processor 16. The watchdog process may monitor a rate at which host processor 16 sends frames to display panel 18 (i.e., the source refresh rate). To monitor the source refresh rate, the watchdog process performs repeatedly performs monitoring cycles. In each monitoring cycle, the watchdog process checks whether host processor 16 has sent content data of a frame to display panel 18 during the time since the previous monitoring cycle. This disclosure refers to the rate at which the watchdog process performs monitoring cycles as the monitoring rate. In some examples, the monitoring rate is marginally greater than a threshold refresh rate. For instance, if the threshold refresh rate is 65 frames per second (fps), the watchdog process may perform 66 monitoring cycles per second. The threshold refresh rate is a rate below which it is more advantageous to operate in the “no frame control” mode than the “full frame control” mode or the “partial frame control” mode. The threshold refresh rate may vary depending on the type of display panel 18. For instance, the threshold refresh rate may vary depending on the resolution of display screen 36 of display panel 18. In some examples, the threshold refresh rate is dependent on a power profile of display panel 18.

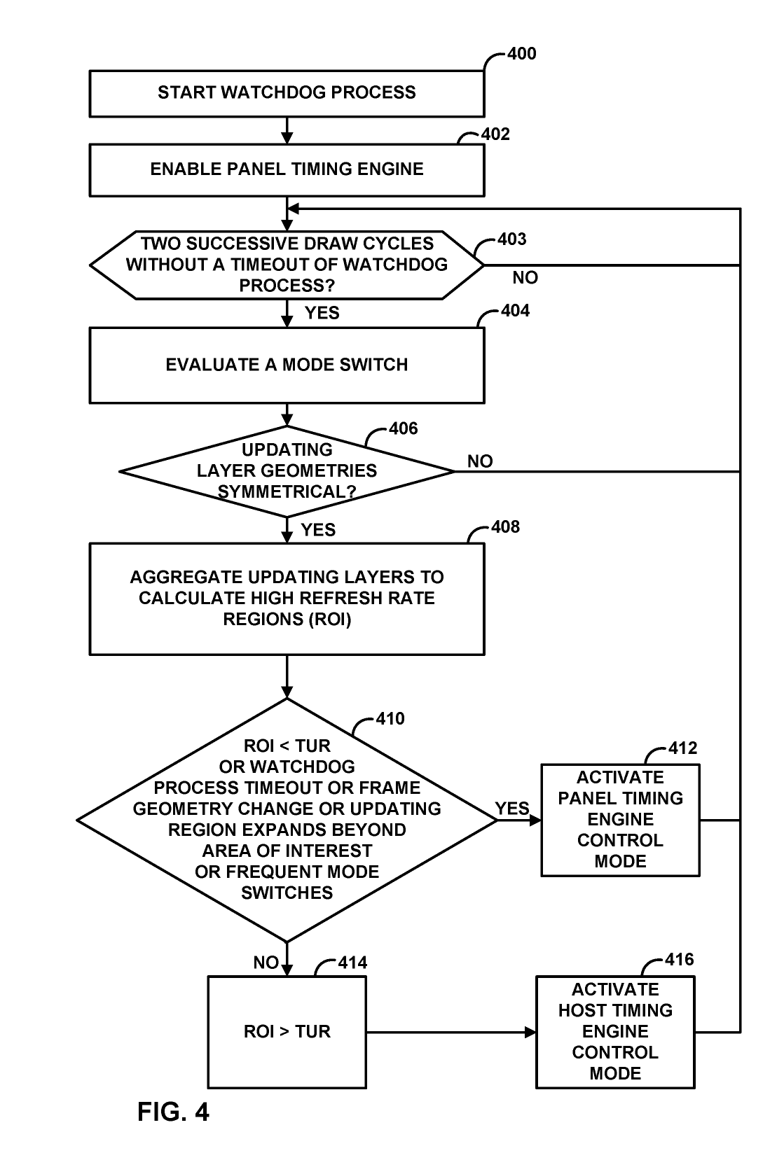

In the example of FIG. 4, host processor 16 may initially enable “no frame control” mode (302). For instance, host processor 16 may instruct display panel 18 to operate in the “no frame control” mode. The no frame control mode is an operating mode where host processor 16 provides updates to panel memory 40 with the latest framebuffer and relinquishes timing control to “slave” panel timing engine 38. In the example of FIG. 4, host processor 16 initially enables the “no frame control” mode because use of the “no frame control” mode ensures that content data is stored into panel memory 40.

Additionally, in the example of FIG. 4, host processor 16 determines whether there have been two successive draw cycles without a timeout of the watchdog process (303). A timeout of the watchdog process occurs when a monitoring cycle of the watchdog process passes without host processor 16 sending content data for a frame to display panel 18. For example, if the threshold refresh rate is 65 fps a timeout of the watchdog process may occur if the watchdog process determines that host processor 16 has not send content data to display panel 18 in the last 1/65 of a second. In this disclosure, a draw cycle is a cycle during which new content is received at host processor 16 which shall be blended and redrawn at display panel 18 (i.e. new content is available for at least one of the layers). Timeout of the watchdog process may indicate a decrease in frame rate (e.g., no new content is fed for scan out). Such a decrease in frame rate may be due to changing of the content (e.g., exiting from a camera application which may change a 60 FPS preview to drop to 15 FPS for a static screen). In response to determining there have not been two successive draw cycles without a timeout of the watchdog process (“NO” branch of 303), system 8 continues operating in the “no frame control” mode and host processor 16 may continue to determine whether there have been two successive draw cycles without a timeout of the watchdog process (303).

The absence of timeouts of the watchdog process means that the source frame rate is faster than the threshold refresh rate. It may be advantageous to use the “partial frame control” mode or the “full frame control” mode when the source frame being faster than the threshold refresh rate. Hence, in response to determining there have been two successive draw cycles without a timeout of the watchdog process (“YES” branch of 303), host processor 16 may evaluate a mode switch (304). In other examples, host processor 16 may evaluate a mode switch based on a greater (e.g., three or more) or smaller (e.g., one) number of successive draw cycles without a timeout of the watchdog process. Actions (306) through (320) of FIG. 3 are parts of the process to evaluate the mode switch.

Thus, in the example of FIG. 3, as part of evaluating the mode switch, host processor 16 determines whether the geometries (i.e., shapes) of the updating layers are symmetrical in consecutive draw cycles (306). Updating layers are layers that host processor 16 is actively updating. In other words, updating layers are high-refresh-rate regions. Host processor 16 may identify high-refresh-rate regions based on a rate at which host processor 16 sends refreshed content data of the region to display panel 18. For instance, region 212 of FIG. 2A is an updating layer, while region 214 is not. Likewise, region 226 of FIG. 2A is an updating layer, while regions 222 and 224 are not. In this disclosure, the geometries of the updating layers of frames drawn in a series of consecutive draw cycles are said to be symmetrical if the updating layers maintain the same shapes, sizes, and positions in the frames. If the geometries of the updating layers are stable (i.e., symmetric) in the frames, it may be advantageous to change to the “partial frame control” mode or the “full frame control” mode. However, if the geometries of the updating layers are not stable in the frames, host processor 16 may be unable to determine whether it would be advantageous to change control modes. Hence, if the geometries of the updating layers are not symmetrical in the consecutive draw cycles (“NO” branch of 306), host processor 16 does not change the control mode and the operation returns to (303).

However, if the geometries of the updating layers are symmetrical in consecutive draw cycles (“YES” branch of 306), host processor 16 may aggregate the sizes of the updating layers to calculate a total size of high refresh rate regions (308). Total size may refer to the combined area, total area, or area of the aggregate region of the high refresh rate regions. This disclosure may refer to high-refresh-rate regions as regions-of-interest (ROIs).

If the total size of the high-refresh-rate regions (i.e., the ROIs) is less than a threshold for updating regions (TUR) (“YES” branch of 310), host processor 16 may instruct display panel 18 to switch to the “no frame control” mode or allow display panel 18 to continue operating in the “no frame control” mode (312). The TUR may be device specific and may be based on a power analysis/profile of the particular computing device and/or display panel. Such power analysis may, for example, analyze power usage with for N lines (where N ranges from 0 to the number of lines) with M pixels per line (where M ranges from 0 to the maximum number of pixels in a line) using full, partial, and no frame control modes. Analysis of power use may also include analysis of different refresh rates of the source content. The analysis of the power for setting the TUR may occur during a design phase for display panel 18, during manufacture, or at another time. TUR may be set to minimize power consumption.

Additionally, if the watchdog monitor times out, there is a change in updating frame layout or geometry, an updating region expands beyond an area of interest, or if host processor 16 determines that there are frequent mode switches (“YES” branch of 310), host processor 16 may instruct display panel 18 to switch to “no frame control” mode or allow display panel 18 to continue operating in the “no frame control” mode (312) and the operation returns to (303).

An updating region expanding beyond an area of interest may occur during a video player window zoom-in or zoom-out as the video player window size changes. Frequent mode switching may include quickly changing 2 or 3 times between modes. Host processor 16 may determine that frequent mode switching is occurring if the number of control mode switches occurring within a particular time period exceeds a threshold value. The threshold value may be specific to a power profile of a particular display panel and may be based on a point at which power costs associated with frequent control mode switches are greater than power savings associated with switching control modes. Frequent control mode changes may occur in boundary cases between control modes, such as when the high-refresh-rate regions and low-refresh-rate regions are approximately equal in size. A geometry change may include a change in program or windowing, switching programs, switching media, or window shape, or other changes to the windows for display.

If none of the foregoing conditions are met (“NO” branch of 310), host processor 16 may determine whether the ROI is the full frame buffer (314). In other words, host processor 16 may determine whether the full frame is a ROI (i.e., a high-refresh-rate region). If the ROI is the full frame buffer (“YES” branch of 314), host processor 16 may instruct display panel 18 to switch to the “full frame control” mode or may allow display panel 18 to continue operating in the “full frame control” mode (316) and the operation returns to (303).

If the ROI is not a full frame buffer (“NO” branch of 314), the total size of the high-refresh-rate regions (i.e., the ROIs) is greater than or equal to the total size of the threshold updating regions (TUR) (318). Hence, host processor 16 instructs display panel 18 to switch to the “partial frame control” mode or may allow display panel 18 to continue operating in the “partial frame control” mode (320) and the operation returns to (303).

FIG. 4 is a flowchart illustrating an example method of mode selection in a frame-based power efficient timing system according to aspects of the present disclosure. In this example, host processor 16 may determine whether to activate a panel timing engine (offline) control mode or a host timing engine (on-the-fly) control mode. While examples of the present techniques are described in terms of steps performed by host timing engine 30 of host processor 16, examples are equally applicable to steps performed by panel timing engine 38 on display panel 18.

Host processor 16 may start a watchdog process (400). The watchdog process may be implement in the same way as the watchdog process described above with respect to FIG. 3 and may provide the same functionality as the watchdog process described above with respect to FIG. 3. Unless otherwise noted, actions performed in the example operation of FIG. 4 may be performed in the same manner as corresponding actions in the example of FIG. 3.

In the example of FIG. 4, host processor 16 initially enables the panel timing engine control mode (402). In panel timing engine control mode, host processor 16 provides updates to panel memory 40 with the latest frame buffer and relinquishes timing control to “slave” panel timing engine 38. In the panel timing engine control mode, panel display controller 46 does not store content data in panel memory 40.

Furthermore, in the example of FIG. 3, host processor 16 determines whether there have been two successive draw cycles without a timeout of the watchdog process (403). In response to determining there have not been two successive draw cycles without a timeout of the watchdog process (“NO” branch of 403), host processor 16 may continue to determine whether there have been two successive draw cycles without a timeout of the watchdog process (403). In response to determining there have been two successive draw cycles without a timeout of the watchdog process (“YES” branch of 403), host processor 16 may evaluate a mode switch (404). In other examples, host processor 16 may evaluate a mode switch based on a greater (e.g., three or more) or smaller (e.g., one) number of successive draw cycles without a timeout of the monitor. Actions (406)-(416) of FIG. 4 are part of evaluating and executing the mode switch.

Thus, as part of evaluating the mode switch, host processor 16 may determine whether the geometries of updating layers are symmetrical in a series of consecutive draw cycles (406). If the geometries of the updating layers are not symmetrical in the series of consecutive draw cycles (“NO” branch of 406), host processor 16 does not change the control mode and the operation returns to (403). If the geometries of the updating layers are symmetrical in the series of consecutive draw cycles (“YES” branch of 406), host processor 16 may aggregate the sizes of the updating layers to calculate a total size of high refresh rate regions and a total size of threshold updating regions (408).

If the total size of the high-refresh-rate regions (i.e., the ROIs) is less than the total size of the threshold updating regions (TUR) (“YES” branch of 410), host processor 16 may activate panel timing engine control mode or continue operating in the panel timing engine control mode (412) and the operation may return to (403). Additionally, if the watchdog process times out, there is a change in updating frame layout or geometry, the updating region expands beyond the area of interest, or if host processor 16 determines there are frequent mode switches to remain in the current mode until the next geometry change (“YES” branch of 410), host processor 16 may activate panel timing engine control mode or continue operating in the panel timing engine control mode (412) and the operation may return to (403).

If none of the foregoing conditions are met (“NO” branch of 410), the total size of the high-refresh-rate regions (i.e., the ROIs) is greater than or equal to the total size of the threshold updating regions (TUR) (414). Hence, host processor 16 activates the host timing engine control mode or continues operating in the host timing engine control mode (416) and the operation may return to (403). In host timing engine mode, host timing engine 30 controls timing for the entire frame and panel memory 40 is bypassed.

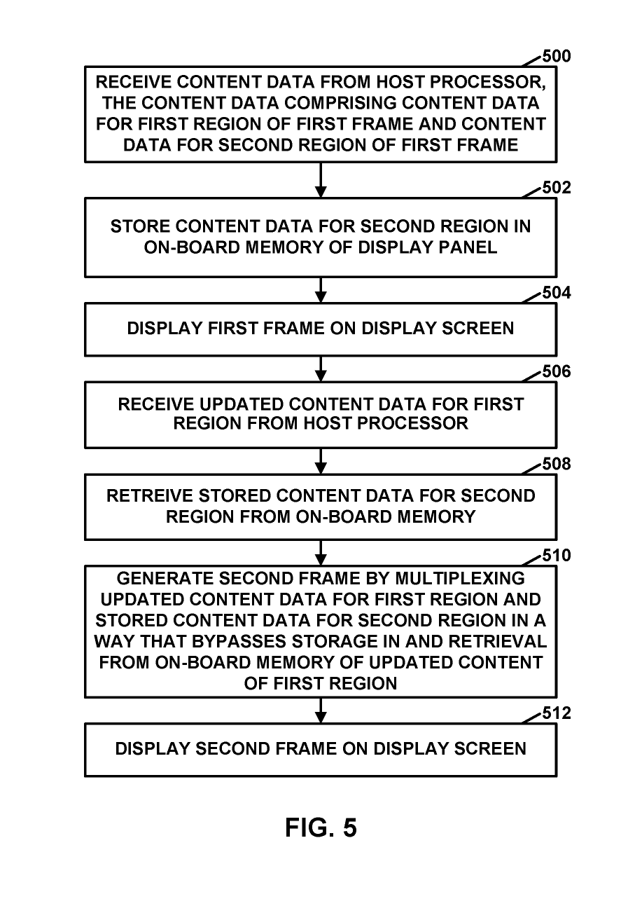

FIG. 5 is a flowchart illustrating an example method of operating a display panel using a block-based timing engine according to aspects of the present disclosure. In the example of FIG. 5, panel display controller 46 of display panel 18 may receive content data from host processor 16 (500). The content data comprises content data for a first region of a first frame and content data for a second region of the first frame. In some examples, the first region is associated with a source refresh rate greater than a source refresh rate associated with the second region. In some examples, host processor 16 instructs panel display controller 46 which pixels of the first frame are in the first region and which pixels of the first frame are in the second region in the form of a bitmap.

In addition, panel display controller 46 stores the content data for the second region in panel memory 40 (i.e., an on-board memory of display panel 18) (502). In typical examples, panel display controller 46 stores the content data for both the first region and the second region in panel memory 40. In some examples, panel display controller 46 stores the content data for the second region in panel memory 40 as a bitmap corresponding to a scan out order of the first frame. Furthermore, in some examples, panel display controller 46 generates the second frame without reading data at addresses of locations in panel memory 40 that correspond to scan out positions of pixels in the first region. Display panel 18 may display the first frame on display screen 36 (504).

In addition, panel display controller 46 may receive updated content data for the first region from host processor 16 (506). Panel display controller 46 may retrieve the stored content data for the second region from panel memory 40 (508). Panel display controller 46 may then generate a second frame by multiplexing the updated content data for the first region and the stored content data for the second region (510). Panel display controller 46 generates the second frame in a way that bypasses storage in and retrieval from panel memory 40 of the updated content data for the first region. For example, the timing may be such that panel display controller 46 receives the updated content data at the time panel display controller 46 is to scan the updated content data out to display screen 36. After displaying the first frame, panel display controller 46 may cause display screen 36 to display the second frame (512).

In some examples, panel display controller 46 receives an indication from host processor 16 to operate in the no frame control mode. The indication may include an instruction received over link 42. In such examples, panel display controller 46 may further receive second content data from host processor 16. In this example, the second content data comprises content data for a third region of a third frame and content data for a fourth region of the third frame. Based on display panel 18 operating in the “no frame control” mode, panel timing engine 38 stores the content data for the third region and the content data for the fourth region in panel memory 40. Additionally, panel display controller 46 may retrieve the stored content data for the third region and the fourth region from panel memory 40. Panel display controller 46 may also cause display screen 36 to display the third frame. Furthermore, panel display controller 46 may receive updated content data for the third region from host processor 16. Panel display controller 46 may store, in panel memory 40, the updated content data for the third region. In some examples, panel display controller 46 may replace the content data for the third region with the updated content data for the third region. Panel display controller 46 may retrieve the update content data for the third region and the content data for the fourth region from panel memory 40. Panel display controller 46 may cause display screen 36 to display a fourth frame. The fourth frame comprises the retrieved content data for the third region and the retrieved content data for the fourth region.

In some examples, panel display controller 46 may receive an indication from host processor 16 to operate in the “full frame control” mode. In such examples, after displaying the second frame, panel display controller 46 may receive an indication from host processor 16 to operate in the “full frame control” mode. The indication may include an instruction received over link 42. Additionally, panel display controller 46 may receive second content data from host processor 16. The second content data comprises content data for a third frame. Based on display panel 18 operating in the “full frame control” mode, panel display controller 46 causes display screen 36 to display the third frame in a way that bypasses storage or retrieval of any of the second content data in panel memory 40. For example, the timing process described elsewhere in this disclosure may be used to bypass such storage and retrieval.

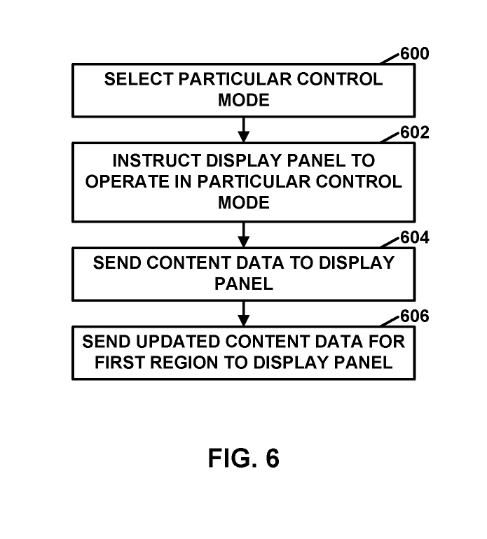

FIG. 6 is a flowchart illustrating an example operation of a host device using a block-based timing engine according to aspects of the present disclosure. For example, the example operation of FIG. 6 may be performed by computing device 10 (FIG. 1).

In the example of FIG. 6, the host device may select a particular control mode from a plurality of control modes (600). The host device may select the particular control mode in various ways.

For example, the first frame may be in a set of consecutive frames (e.g., a pair of consecutive frames, three consecutive frames, etc.) and the host device may select the partial control mode in response to determining that regions of the set of consecutive frames associated with a higher refresh rate are larger than a threshold. In some examples, the threshold is 50% of screen area, 30% of screen area, etc. Thus, in the example where the threshold is 50% of screen area, the host device may select the partial control mode in response to determining that regions of the set of consecutive frames associated with a higher refresh rate are larger than regions of the set of consecutive frames associated with a lower refresh rate, where the higher refresh rate is higher than the lower refresh rate.

In another example, the first frame may be in a set of consecutive frames and the host device may select the full frame control mode in response to determining that all regions of the consecutive frames are refreshed in each of the consecutive frames.

In another example, the first frame may be in a set of consecutive frames and the host device may select the no frame control mode in response to determining that regions of the set of consecutive frames associated with a higher refresh rate are smaller than a threshold, such as a total size of lower-refresh-rate regions in a frame of the set of consecutive frames.

In some examples, the host device may select the no frame control mode in response to determining that a frame geometry of frames in the set of consecutive frames has changed. For instance, the host device may select the no frame control mode in response to determining an orientation of display screen 36 has changed from portrait to landscape, or vice versa. Furthermore, in some examples, the host device may select the no frame control mode in response to determining that a region of interest in the set of consecutive frames has expanded.

Additionally, in the example of FIG. 6, the host device instructs display panel 18 to operate in the particular control mode (602). For instance, the host device may send an indication of the particular control mode via bus interface 26.

Furthermore, the host device sends content data to display panel 18 (604). The content data comprises content data for a first region of a first frame and content data for a second region of the first frame. Subsequently, the host device also sends updated content data for the first region to display panel 18 (606).

In the example of FIG. 6, based on the particular control mode being the partial frame control mode, instructing to display panel 18 to operate in the particular control mode configures display panel 18 to store the content data for the second region in an on-board memory of display panel 18 (i.e., panel memory 40). Additionally, display panel 18 displays the first frame on display screen 36. Display panel 18 also retrieves the stored content data for the second region from the on-board memory. Furthermore, display panel 18 generates a second frame by multiplexing the updated content data for the first region and the stored content data for the second region. Display panel 18 generates the second frame in a way that bypasses storage in and retrieval from the on-board memory of the updated content data for the first region. After displaying the first frame, display panel 18 may display the second frame on the display screen.

In some examples, the host device may instruct display panel 18 to switch from the partial frame control mode to the full frame control mode. Thus, in such examples, the host device may select a second control mode (i.e., the full frame control mode) from the plurality of control modes. Additionally, the host device may instruct display panel 18 to operate in the second control mode instead of the first control mode (i.e., the partial control mode). Furthermore, the host device may send second content data to display panel 18. The second content data comprises content data for a third frame. Instructing display panel 18 to operate in the second control mode configures display panel 18 to display the third frame on the display screen in a way that bypasses storage or retrieval of any of the second content data in the on-board memory (i.e., panel memory 40).

In some examples, the host device may instruct display panel to switch from the partial frame control mode to the no frame control mode. Thus, in such examples, the host device may select a second control mode (i.e., the no frame control mode) from the plurality of control modes. Additionally, the host device may instruct display panel 18 to operate in the second control mode instead of the first control mode (i.e., the partial frame control mode). Furthermore, the host device may send second content data to display panel 18. The second content data comprises content data for a third region of a third frame and content data for a fourth region of the third frame. Additionally, the host device sends updated content data for the third region to display panel 18. Instructing display panel 18 to operate in the second control mode may configure display panel 18 to store the content data for the third region and the content data for the fourth region in the on-board memory. Additionally, display panel 18 is configured to retrieve the stored content data for the third region and the fourth region from the on-board memory. Display panel 18 is also configured to display the third frame on display screen 36. In addition, display panel 18 is configured to store, in the on-board memory, the updated content data for the third region. In some examples, display panel 18 is configured to replace, in the on-board memory, the content data for the third region with the updated content data for the third region. Display panel 18 is also configured such that display panel 18 retrieves the updated content data for the third region and the content data for the fourth region from the on-board memory. Display panel 18 may display a fourth frame on display screen 36. The fourth frame comprises the retrieved updated content data for the third region and the retrieved content data for the fourth region.

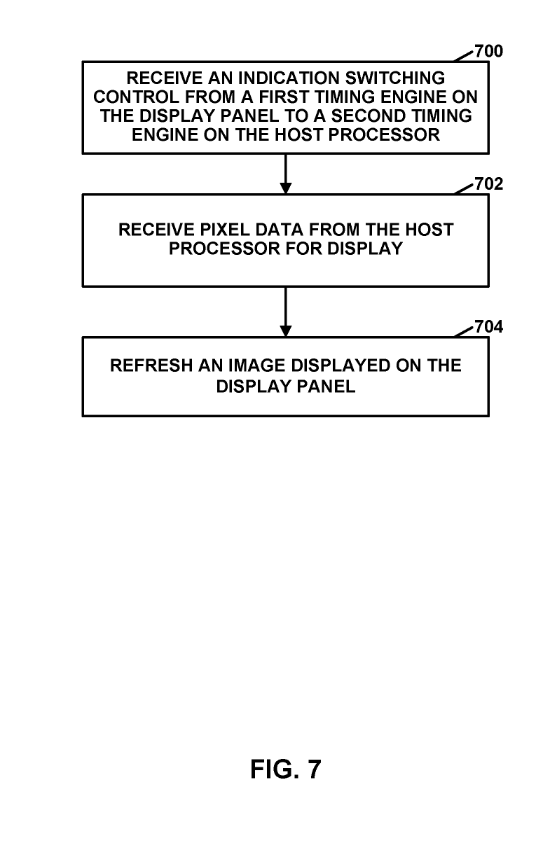

FIG. 7 is a flowchart illustrating an example method of operating a display panel using a frame-based timing engine according to aspects of the present disclosure. In the example of FIG. 7, panel display controller 46 of display panel 18 may receive an indication from host processor 16 on a host device switching control from a panel timing engine 38 on display panel 18 to panel timing engine 38 on the host processor 16 to control a display image on the display panel (700). The indication may be an instruction received via link 42. Receiving the indication may be based, at least in part, on: (i) a determination that on consecutive draw cycles a same region is updated, (ii) a determination of high refresh rate regions from the same region, (iii) a comparison between the high refresh rate regions with a threshold, and/or (iv) a determination that the high refresh rate regions is larger than the threshold. Receiving the indication may also be based, at least in part, on a determination of a number of high refresh rate regions in a display frame based on differences between consecutive display frames and a determination that the number of high refresh rate regions is larger than a threshold. The threshold may be based on a power analysis of display panel 18. The determination of the number of high refresh rate regions may include monitoring a content source refresh rate.

Panel display controller 46 of display panel 18 may receive pixel data from host processor 16 for display (702). Additionally, panel display controller 46 may refresh an image displayed on display screen 36 with the pixel data received from host processor 16 without storing that the pixel data in panel memory 40 of display panel 18, based on receiving the indication (704). Refreshing the image may be based on a timing provided by host timing engine 30.

Panel display controller 46 may receive a second indication from host processor 16 switching control from the second timing engine on the host processor to the first timing engine on the display panel. Receiving the second indication may be based, at least in part, on a determination that on consecutive draw cycles a same set of layers are not updated. Receiving the second indication may be based, at least in part, on a determination of high refresh rate regions from the same set of layers and the comparison the high refresh rate regions with a threshold, and a determination that the high refresh rate regions is not larger than the threshold.

Receiving the second indication may be based, at least in part, on a determination of a frequent switching of control from panel timing engine 38 to host timing engine 30 and back to panel timing engine 38. Panel display controller 46 of display panel 18 may receiving second pixel data from the host device for display. Panel display controller 46 of display panel 18 may store the second pixel data in panel memory 40 of display panel 18, based on receiving the second indication. Panel display controller 46 of display panel 18 may refresh the image displayed on display panel 18 with the second pixel data received from the host processor based on receiving the second indication. Panel timing engine 38 of display panel 18 may determine a timing for display of the second pixel data. Refreshing the image displayed on the display panel may be based on the timing provided by host timing engine 30.

Testing power usage in an exemplary frame-based timing engine system has shown significant power improvements over a system that does not use a frame-based timing engine approach. In the example system, the non-frame based timing engine approach may be similar to a system that only uses panel timing engine mode and does not evaluate mode switching/activation. In one exemplary test, the evaluation conditions were for 60 frames per second (fps) content with a resolution of 1440×2560 pixels, 60 Hz liquid crystal display (LCD) smart display panel. The display using the frame-based timing engine used 479.25 mA, whereas the display that did not use the frame-based timing engine used 497.44 mA. In this test, 18.19 mA was the measured power savings for using the frame-based timing engine technique which was determined to be a statistically significant result.

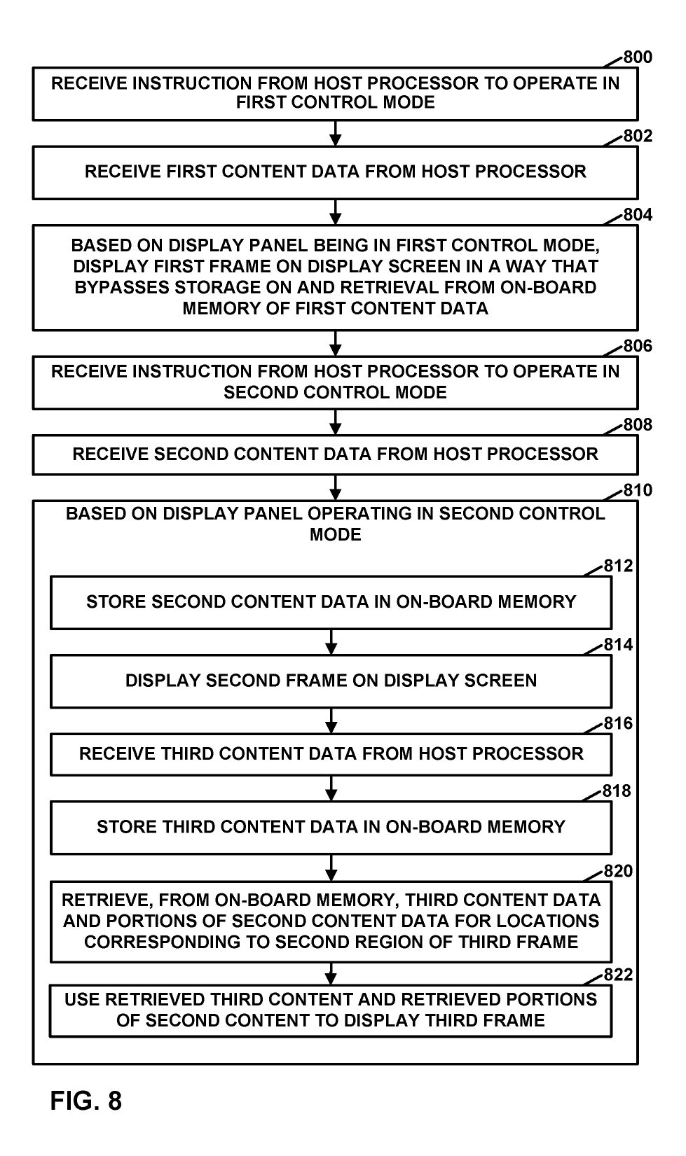

FIG. 8 is a flowchart illustrating an example method of operating display panel 18 using a frame-based timing engine according to aspects of the present disclosure. In the example of FIG. 8, display panel 18 receives an instruction from host processor 16 on a host device (e.g., computing device 10) to operate in a first control mode (800). In the example of FIG. 8, the “first control mode” is the host timing engine mode. Additionally, display panel 18 may receive first content data from host processor 16 (802). The first content data comprises pixel values of a first frame. Based on the display panel operating in the first control mode (i.e., the host timing engine mode), display panel 18 displays the first frame on display screen 36 in a way that bypasses storage on and retrieval from panel memory 40 (i.e., an on-board memory) of the first content data (804).

Before or after actions (800) through (804), display panel 18 may receive an instruction from host processor 16 to operate in a second control mode (806). In the example of FIG. 8, the “second control mode” is the panel timing engine mode. Additionally, display panel 18 may receive second content data from host processor 16 (808). The second content data comprises pixel values of a second frame.

Display panel 18 may receive the instruction to operating the second control mode when various conditions occur. For example, display panel 18 may receive the instruction to operate in the second control mode based on: a determination that on consecutive draw cycles a same region is updated, a determination of high refresh rate regions from the same region, a comparison between the high refresh rate regions with a threshold, or a determination that the high refresh rate regions is larger than the threshold. In some examples, display panel 18 receives the instruction to operate in the second control mode based on a same set of layers having the same size and content in consecutive draw cycles. Furthermore, in some examples, display panel 18 receives the instruction to operate in the second control mode based on regions of a set of consecutive frames associated with a higher refresh rate being smaller than a threshold (e.g., a predetermined threshold, a size of regions of the set of consecutive frames associated with a lower refresh rate, etc.). In some examples, display panel 18 receives the instruction to operate in the second control mode based on a number of times a control mode has changed between the first control mode and the second control mode in a time period being greater than a threshold.

Display panel 18 may then perform a series of actions (810) based on display panel 18 operating in the second control mode (i.e., the panel timing engine mode). For instance, as shown in the example of FIG. 8, display panel 18 may store the second content data in panel memory 40 (i.e., the on-board memory) (812). In some examples, display panel 18 stores the second content data in panel memory 40 as a bitmap corresponding to a scan out order of the second frame. Furthermore, display panel 18 may display the second frame on display screen 36 (814). In the second control mode, display panel 18 may need to retrieve the content data of the second frame from panel memory 40 prior to displaying the second frame. Additionally, in the example of FIG. 8, display panel 18 may receive third content data from host processor 16 (816). The third content data comprises pixel values of a first region of a third frame. In some examples, the third content data does not include pixel values of a second region of the third frame. Display panel 18 may store the third content data in the on-board memory (818). In some examples, display panel 18 stores the third content data in panel memory 40 such that the third content data replaces portions of the second content data for locations corresponding to the first region of the third frame. Additionally, display panel 18 retrieves, from the on-board memory, the third content data and portions of the second content data for locations corresponding to the second region of the third frame (820). Display panel 18 may then use the retrieved third content data and the retrieved portions of the second content data to display the third frame on display screen 36 (822).

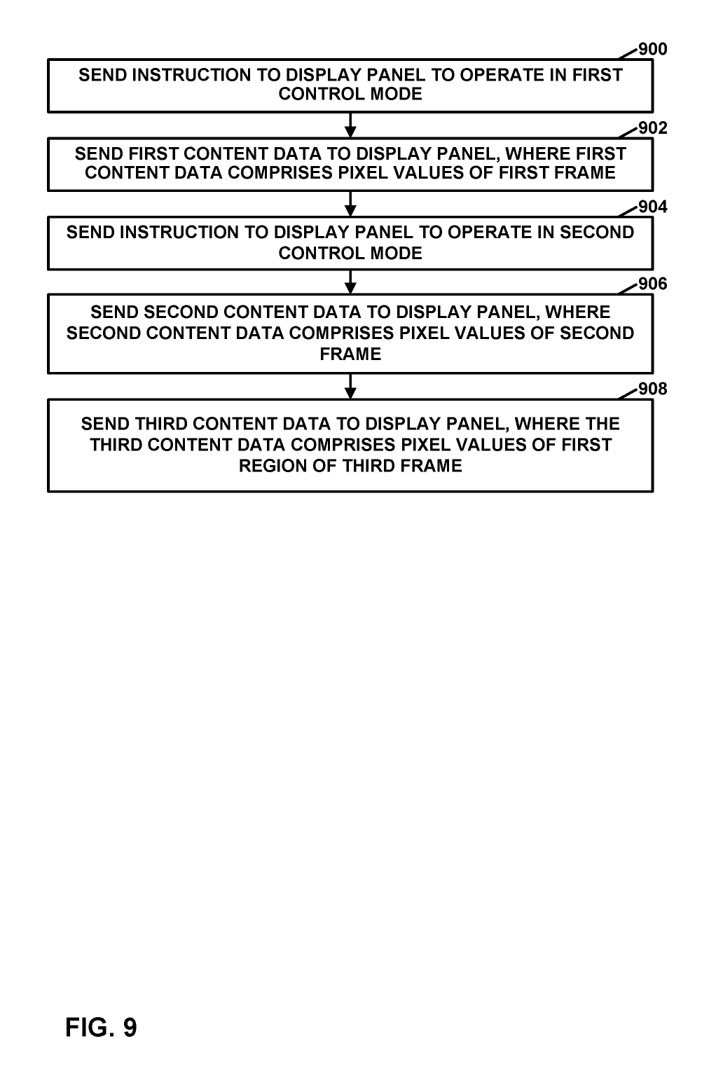

FIG. 9 is a flowchart illustrating an example operation of a host device using a block-based timing engine according to aspects of the present disclosure. Computing device 10 (FIG. 1) may be the host device of FIG. 9.

In the example of FIG. 9, host processor 16 of the host device sends an instruction to display panel 18 to operate in a first control mode (900). In some examples, host processor 16 may determine that display panel 18 is to operate in the first control mode based on regions of a set of consecutive frames associated with a higher refresh rate being larger than a threshold, such as the size of regions of the set of consecutive frames associated with a lower refresh rate.

In the example of FIG. 9, the first control mode is the host timing engine mode. Additionally, host processor 16 sends first content data to the display panel (902). The first content data comprises pixel values of a first frame. Instructing display panel 18 to operate in the first control mode configures display panel 18 to display the first frame on display screen 36 in a way that bypasses storage on and retrieval from panel memory 40 (i.e., an on-board memory) of the first content data.

Before or after actions (900) through (902), host processor 16 may send an instruction to display panel 18 to operate in a second control mode (904). Host processor 16 may determine that display panel 18 is to operate in the second control mode in response to various conditions. For example, host processor 16 may determine that display panel 18 is to operate in the second control mode based on regions of the set of consecutive frames associated with a higher refresh rate being smaller than a threshold (e.g., a predetermined threshold, a size of regions of the set of consecutive frames associated with a lower refresh rate, etc.). In some examples, host processor 16 may determine that display panel 18 is to operate in the second control mode based on a frame geometry of frames in the set of consecutive frames having changed. In some examples, host processor 16 may determine that display panel 18 is to operate in the second control mode based on a region of interest in the set of consecutive frames having expanded. In some examples, host processor 16 may determine that display panel 18 is to operate in the second control mode based on a number of times a control mode has changed between the first control mode and the second control mode in a time period being greater than a threshold.

In the example of FIG. 9, the second control mode is the panel timing engine mode. Furthermore, host processor 16 may send second content data to display panel 18 (906). The second content data comprises pixel values of a second frame. Host processor 16 may also send third content data to display panel 18 (908). The third content data comprises pixel values of a first region of a third frame. In some examples, the third content data does not comprise pixel values of a second region of the third frame.

Instructing display panel 18 to operate in the second control mode configures display panel 18 to store the second content data in the on-board memory and display the second frame on display screen 36. In the second control mode, display panel 18 may need to retrieve the second content data from panel memory 40 prior to displaying the second frame. Additionally, because panel display 18 is operating in the panel timing engine mode, panel display 18 stores the third content data in panel memory 40. In some examples, display panel 18 stores the third content data in panel memory 40 such that the third content data replaces portions of the second content data for locations corresponding to the first region of the third frame. Furthermore, display panel 18 retrieves, from panel memory 40, the third content data and portions of the second content data for locations corresponding to the second region of the third frame. Display panel 18 may use the retrieved third content data and the retrieved portions of the second content data to display the third frame on display screen 36.

The smart phone industry has transitioned to smart display panels in recent years which includes original equipment manufacturers (OEMs) ranged from premium tier to value tier segments. Therefore, use of this technique may be beneficial throughout the market for smart phones. Furthermore, the optimizations disclosed herein may reduce prolonged redundant memory transactions extensively thus potentially reducing RAM wear out.

In one or more examples, the functions described may be implemented in hardware, software, firmware, or any combination thereof. If implemented in software, the functions may be stored on or transmitted over as one or more instructions or code on a computer-readable medium. Computer-readable media may include computer data storage media or communication media including any medium that facilitates transfer of a computer program from one place to another. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices, cache memory, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” and “processing unit,” as used herein may refer to any of the foregoing structure or any other structure suitable for implementation on of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements. In this disclosure, the phase “based on” may indicate “based at least in part on.”

The techniques of this disclosure may be implemented in a wide variety of devices or apparatuses, including a wireless handset, an integrated circuit (IC) or a set of ICs (i.e., a chip set). Various components, modules or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various aspects of the disclosure have been described. These and other embodiments are within the scope of the following claims.

What is claimed is:

1. A method of operating a display panel, the method comprising:
receiving, by the display panel, content data from a host processor, the content data comprising content data for a first region of a first frame and content data for a second region of the first frame;
storing the content data for the second region in an on-board memory of the display panel;
displaying the first frame on a display screen of the display panel;
receiving, by the display panel, updated content data for the first region from the host processor;
retrieving, by the display panel, the stored content data for the second region from the on-board memory;
generating, by the display panel, a second frame by multiplexing the updated content data for the first region and the stored content data for the second region, wherein the display panel generates the second frame in a way that bypasses storage in and retrieval from the on-board memory of the updated content data for the first region; and
after displaying the first frame, displaying the second frame on the display screen.

2. The method of claim 1, further comprising:
after displaying the second frame, receiving, by the display panel, an indication from the host processor to operate in a particular control mode;
receiving, by the display panel, second content data from the host processor, the second content data comprising content data for a third region of a third frame and content data for a fourth region of the third frame; and
based on the display panel operating in the particular control mode:
storing the content data for the third region and the content data for the fourth region in the on-board memory;
displaying the third frame on the display screen;
receiving, by the display panel, updated content data for the third region from the host processor;
storing, in the on-board memory, the updated content data for the third region;
retrieving, by the display panel, the updated content data for the third region and the content data for the fourth region from the on-board memory; and
displaying a fourth frame on the display screen, the fourth frame comprising the retrieved updated content data for the third region and the retrieved content data for the fourth region.

3. The method of claim 1, further comprising:
after displaying the second frame, receiving, by the display panel, an indication from the host processor to operate in a particular control mode;
receiving, by the display panel, second content data from the host processor, the second content data comprising content data for a third frame; and
based on the display panel operating in the particular control mode, displaying the third frame on the display screen in a way that bypasses storage in and retrieval from the on-board memory by any of the second content data.

4. The method of claim 1, wherein storing the content data for the second region comprises storing the content data for the second region in the on-board memory as a bitmap corresponding to a scan out order of the first frame.

5. The method of claim 4, wherein the display panel generates the second frame without reading data at addresses of locations in the on-board memory that correspond to scan out positions of pixels in the first region.

6. The method of claim 1, wherein the first region is associated with a source refresh rate greater than a source refresh rate associated with the second region.

7. A method of operating a display panel, the method comprising:
selecting, by a host device, a particular control mode from a plurality of control modes;
instructing, by the host device, the display panel to operate in the particular control mode;
sending, by the host device, content data to the display panel, the content data comprising content data for a first region of a first frame and content data for a second region of the first frame; and
sending, by the host device, updated content data for the first region to the display panel,
wherein instructing to the display panel to operate in the particular control mode configures the display panel to:
store the content data for the second region in an on-board memory of the display panel;
display the first frame on a display screen of the display panel;
retrieve the stored content data for the second region from the on-board memory;
generate a second frame by multiplexing the updated content data for the first region and the stored content data for the second region, wherein the display panel generates the second frame in a way that bypasses storage in and retrieval from the on-board memory of the updated content data for the first region; and
after displaying the first frame, display the second frame on the display screen.

8. The method of claim 7, wherein the particular control mode is a first control mode in the plurality of control modes, the method further comprising:
selecting, by the host device, a second control mode from the plurality of control modes;
instructing, by the host device, the display panel to operate in the second control mode instead of the first control mode;
sending, by the host device, second content data to the display panel, the second content data comprising content data for a third region of a third frame and content data for a fourth region of the third frame; and
sending, by the host device, updated content data for the third region to the display panel,
wherein instructing the display panel to operate in the second control mode configures the display panel to:
store the content data for the third region and the content data for the fourth region in the on-board memory;
display the third frame on the display screen;
store, in the on-board memory, the updated content data for the third region;
retrieve the updated content data for the third region and the content data for the fourth region from the on-board memory; and
display a fourth frame on the display screen, the fourth frame comprising the retrieved updated content data for the third region and the retrieved content data for the fourth region.

9. The method of claim 8, wherein the third frame is in a set of consecutive frames, and selecting the second control mode comprises:
selecting, by the host device, the second control mode instead of the first control mode in response to determining that regions of the set of consecutive frames associated with a higher refresh rate are smaller than a threshold.

10. The method of claim 8, wherein the third frame is in a set of consecutive frames, and selecting the second control mode comprises:
selecting, by the host device, the second control mode instead of the first control mode in response to determining that a frame geometry of frames in the set of consecutive frames has changed.

11. The method of claim 8, wherein the third frame is in a set of consecutive frames, and selecting the second control mode comprises:
selecting, by the host device, the second control mode instead of the first control mode in response to determining that a region of interest in the set of consecutive frames has expanded.

12. The method of claim 7, wherein the particular control mode is a first control mode in the plurality of control modes, the further comprising:
selecting, by the host device, a second control mode from the plurality of control modes;
instructing, by the host device, the display panel to operate in the second control mode instead of the first control mode; and
sending, by the display panel, second content data to the display panel, the second content data comprising content data for a third frame,
wherein instructing the display panel to operate in the second control mode configures the display panel to display the third frame on the display screen in a way that bypasses storage in and retrieval from the on-board memory by any of the second content data.

13. The method of claim 12, wherein the third frame is in a set of consecutive frames, and selecting the second control mode comprises:
selecting, by the host device, the second control mode instead of the first control mode in response to determining that all regions of the consecutive frames are refreshed in each of the consecutive frames.

14. The method of claim 7, wherein the first frame is in a set of consecutive frames, and selecting the particular control mode comprises:
selecting, by the host device, the particular control mode in response to determining that regions of the set of consecutive frames associated with a higher refresh rate are larger than regions of the set of consecutive frames associated with a lower refresh rate, the higher refresh rate being higher than the lower refresh rate.

15. A display panel comprising:
an interface;
an on-board memory;
a display screen; and
a display controller, wherein:
the interface is configured to receive content data from a host processor, the content data comprising content data for a first region of a first frame and content data for a second region of the first frame,
the on-board memory is configured to store the content data for the second region,
the display screen is configured to display the first frame,
the interface is further configured to receive updated content data for the first region from the host processor, and
the display controller is configured to:
retrieve the stored content data for the second region from the on-board memory; and
generate a second frame by multiplexing the updated content data for the first region and the stored content data for the second region, wherein the display controller generates the second frame in a way that storage in and retrieval from the on-board memory of the updated content data for the first region is bypassed; and
the display screen is configured to display the second frame after displaying the first frame.

16. The display panel of claim 15, wherein:
the interface is further configured to:
receive an indication from the host processor to operate in a particular control mode;
receive second content data from the host processor, the second content data comprising content data for a third region of a third frame and content data for a fourth region of the third frame; and
receive, by the display panel, updated content data for the third region from the host processor, and
the indication to operate in the particular control mode configures the display controller to:
store the content data for the third region and the content data for the fourth region in the on-board memory;
cause the display screen to display the third frame;
after retrieving the content data for the third region, store, in the on-board memory, the updated content data for the third region;
retrieve the updated content data for the third region and the content data for the fourth region from the on-board memory; and
cause the display screen to display a fourth frame, the fourth frame comprising the retrieved updated content data for the third region and the retrieved content data for the fourth region.

17. The display panel of claim 15,
wherein the interface is further configured to:
receive an indication from the host processor to operate in a particular control mode; and
receive, by the display panel, second content data from the host processor, the second content data comprising content data for a third frame; and
wherein the indication to operate in the particular control mode configures the display controller to cause the display screen to display the third frame in a way that bypasses storage in and retrieval from the on-board memory by any of the second content data.

18. The display panel of claim 15, wherein the on-board memory is configured to store the content data for the second region as a bitmap corresponding to a scan out order of the first frame.

19. The display panel of claim 18, wherein the display controller is configured to generate the second frame without reading data at addresses of locations in the on-board memory that correspond to scan out positions of pixels in the first region.

20. The display panel of claim 15, wherein the first region is associated with a source refresh rate greater than a source refresh rate associated with the second region.

21. A host device for operating a display panel, the host device comprising:
an interface; and
a host processor configured to:
select a particular control mode from a plurality of control modes;
instruct, via the interface, the display panel to operate in the particular control mode;
send, via the interface, content data to the display panel, the content data comprising content data for a first region of a first frame and content data for a second region of the first frame;
send, via the interface, updated content data for the first region to the display panel,
wherein instructing to the display panel to operate in the particular control mode configures the display panel to:
store the content data for the second region in an on-board memory of the display panel;
display the first frame on a display screen of the display panel;
retrieve the stored content data for the second region from the on-board memory;
generate a second frame by multiplexing the updated content data for the first region and the stored content data for the second region, wherein the display panel generates the second frame in a way that bypasses storage in and retrieval from the on-board memory of the updated content data for the first region; and
after displaying the first frame, display the second frame on the display screen.

22. The host device of claim 21, wherein the particular control mode is a first control mode in the plurality of control modes, the host processor further configured to:
select a second control mode from the plurality of control modes;
instruct the display panel to operate in the second control mode instead of the first control mode;
send second content data to the display panel, the second content data comprising content data for a third region of a third frame and content data for a fourth region of the third frame;
send updated content data for the third region to the display panel,
wherein instructing the display panel to operate in the second control mode configures the display panel to:
store the content data for the third region and the content data for the fourth region in the on-board memory;
display the third frame on the display screen;
store, in the on-board memory, the updated content data for the third region;
retrieve the updated content data for the third region and the content data for the fourth region from the on-board memory; and
display a fourth frame on the display screen, the fourth frame comprising the retrieved updated content data for the third region and the retrieved content data for the fourth region.

23. The host device of claim 22, wherein the third frame is in a set of consecutive frames, and the host processor is configured to select the second control mode instead of the first control mode in response to determining that regions of the set of consecutive frames associated with a higher refresh rate are smaller than a threshold.

24. The host device of claim 22, wherein the third frame is in a set of consecutive frames, and the host processor is configured to select the second control mode instead of the first control mode in response to determining that a frame geometry of frames in the set of consecutive frames has changed.

25. The host device of claim 22, wherein the third frame is in a set of consecutive frames, and the host processor is configured to select the second control mode instead of the first control mode in response to determining that a region of interest in the set of consecutive frames has expanded.

26. The host device of claim 21, wherein the particular control mode is a first control mode in the plurality of control modes, the host processor further configured to:
select a second control mode from the plurality of control modes;
instruct the display panel to operate in the second control mode instead of the first control mode;
send second content data to the display panel, the second content data comprising content data for a third frame, and
wherein instructing the display panel to operate in the second control mode configures the display panel to display the third frame on the display screen in a way that bypasses storage in and retrieval from the on-board memory by any of the second content data.

27. The host device of claim 26, wherein the third frame is in a set of consecutive frames, and the host processor is configured to select the second control mode instead of the first control mode in response to determining that all regions of the consecutive frames are refreshed in each of the consecutive frames.

28. The host device of claim 21, wherein the first frame is in a set of consecutive frames, and the host processor is configured to select the particular control mode in response to determining that regions of the set of consecutive frames associated with a higher refresh rate are larger than regions of the set of consecutive frames associated with a lower refresh rate, the higher refresh rate being higher than the lower refresh rate.
